(19) United States
(12) Patent Application Publication
(10) Pub. No.: US 2006/0192395 A1
(43) Pub. Date: Aug. 31, 2006

(54) Releasable, resettable latch mechanism

(76) Inventor: Francis J. McCabe, Ottville, PA (US)

Correspondence Address: BENASUTTI, P.A., 17294 BERMUDA VILLAGE DRIVE, BOCA RATON, FL, 33487, US

(21) Appl. No.: 11/067,365

(22) Filed: Feb. 25, 2005

(51) Int. Cl. E05C 1/06

(52) U.S. Cl. 292/144

(57) ABSTRACT

A door or hatch capable of moving between an open and closed position and normally biased to revert to one of those positions is retained by a manually operable retaining means. A release means is provided to automatically release the door or hatch to thereby allow it to return to its biased position, automatically. The release means is operable in normal ambient temperature for automatically releasing the door or hatch and operable under fire conditions for automatically releasing the door or hatch.

### BACKGROUND OF THE INVENTION

1. Field of Invention

This invention relates to manual latch mechanisms as used, for example, in doors, vents and the like, and more particularly, to a release means for releasing the manual latch mechanism so that the door, vent or the like can be closed.

2. Prior Art

In the prior art it is known to retain doors, vents or the like (herein after, collectively, doors) in an open condition by providing a latch attached to the door which engages a mating part when the door is fully opened to prevent the door from closing. This part may be fixed to a wall or door jam. The engagement is such that the door may be manually pulled to disengage the latch from its mating part, thereby permitting the door to be closed.

Many doors are spring biased, so that once released, they close automatically.

There is a need to provide a release means to automatically release the door latch mechanism and allow the door to close, such as, in the event of a fire or simply to control access through the door or vent, etc. It is an object of my invention to provide such a release means.

### SUMMARY OF THE INVENTION

My invention provides a release means for releasing a manually operable retaining means for a door, vent hood or the like (herein after, a closure means) to thereby allow the same to open or close automatically. The release means is connected to a manually operable retaining means used for retaining the closure means, for automatically releasing the closure means to thereby allow the closure means to open or close automatically. The release means is operable in normal ambient temperature and under fire conditions.

### BRIEF DESCRIPTION OF THE DRAWINGS

FIG. 1 is a top schematic view of a door and release means (apparatus) in accordance with my invention;

FIG. 2 is a side elevation of a portion of the apparatus shown in FIG. 1; with an alternate position shown in phantom lines;

FIG. 3 is a partial top view taken along the lines and arrows “A-A” in FIG. 2;

FIG. 4 is a side elevation of an alternate embodiment of a portion of the apparatus;

FIG. 5 is a side elevation of another alternate embodiment of a portion of the apparatus;

FIG. 6 is a top view of a portion of the apparatus shown in FIG. 2; also shown is an alternate embodiment of my invention;

FIG. 7 is a side elevation of another alternate embodiment of a portion of the apparatus;

FIG. 8 is a side elevation of another alternate embodiment of a portion of the apparatus; with an alternate position shown in phantom lines;

FIG. 9 is a top view of another embodiment of my invention; with an alternate position shown in phantom lines;

FIG. 10 is a wiring schematic of a portion of the apparatus shown in FIG. 2; with an alternate position shown in phantom lines;

FIG. 11 is a top view of a portion of the apparatus shown in FIG. 2;

FIG. 12 is a top view of a portion of the apparatus shown in FIG. 2 in an alternate position; and

FIG. 13 is a partial section of another embodiment of my invention taken along the lines and arrows G-G in FIG. 6; with an alternate position shown in phantom lines.

### DETAILED DESCRIPTION OF THE INVENTION

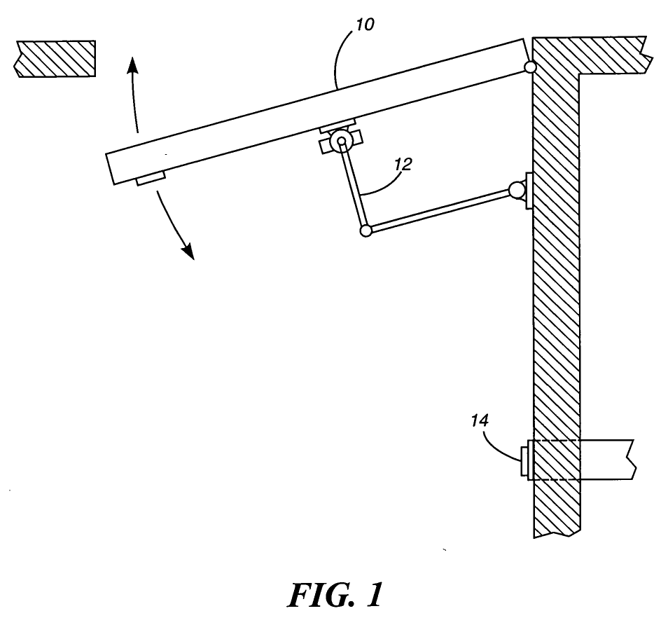

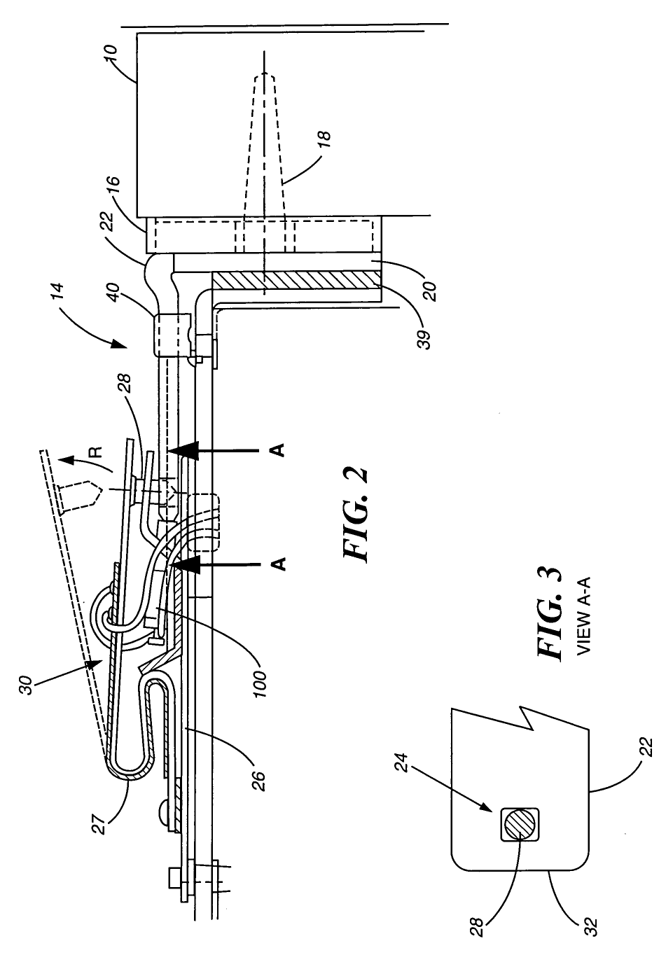

FIG. 1 is a schematic representation of a door 10 and closure mechanism 12 as viewed from above. The door can be held open when fully open by a latch mechanism designated generally 14; which is releaseable by manually pulling on it. Such a mechanism may be a magnet 16; as shown in side elevation in FIG. 2.

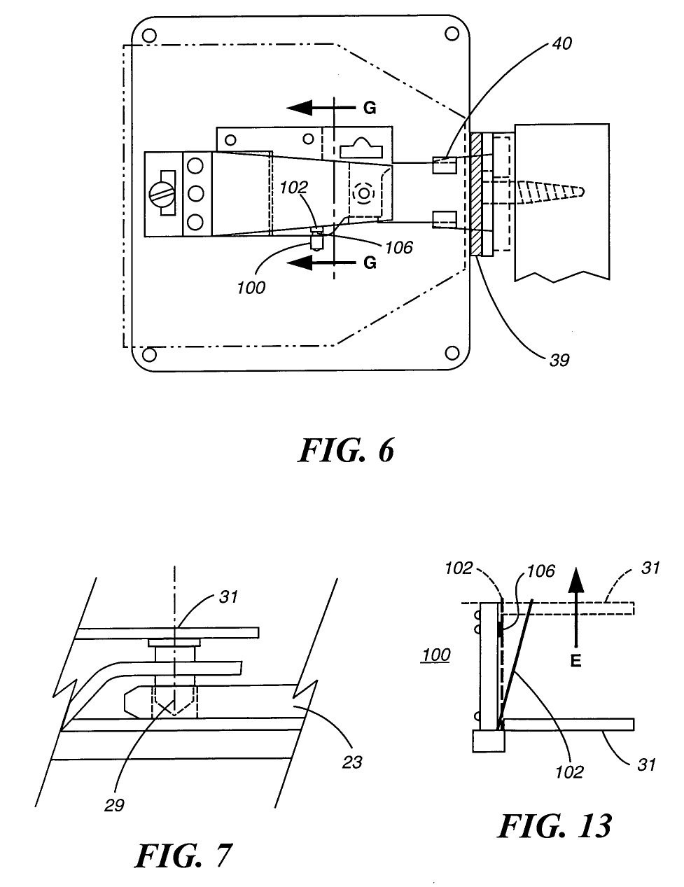

The magnet 16 is retained on the door 10 by any suitable means, such as the screw 18. The magnet engages and attaches magnetically to a flat, downwardly depending metal tab 20 which is part of the pawl 22 of a latch mechanism designated generally 14. The latch mechanism 14 has a base 26 which is fixed to the wall or door jam. In the embodiment shown, the latch mechanism also has a pin 28 fixedly mounted to the moveable end of a heat actuated clip, designated generally 30. This clip may be of the type shown in my prior U.S. Pat. No. 4,905,344. The free end 32 (FIG. 3) of the pawl 22 has a hole 24 in it, so that the pin 28 can retain the pawl in the latched condition shown in FIG. 2. A pawl guide 40 is provided mounted on the wall or jam, to guide the movement of the pawl 22. See FIG. 6.

To latch the pawl when the door is opened, the free end of the pawl contacts the beveled end of the pin 28 and raises it out of the way against the spring force of the clip arm 31. The pin rides over the pawl until it drops into the hole 24. The front end of the pawl is preferably rounded to enhance the ease of this interaction.

To prevent damage to the clip, a cushion material 39 is attached to the wall to engage the downwardly depending tap 20 and absorb the thrust of the door.

To release the pawl (and thus release the door), heat expands the bi-metal clip thereby pulling the pin 28 out of the hole 24 (in the direction of the arrow “R”, FIG. 2) in the pawl 22. Thus the mounting, in this case the pawl, for the magnet is released and will travel with the door to the closed position.

The source of the heat may be hot air from a fire or electric power applied directly to the bi-metal material of the clip itself or to the heating pad 27 connected to the surface of the bi-metal clip arm 31, to provide resistance heat to the bi-metal clip.

Thus I have provided a release means connected to a manually operable retaining means used for retaining a closure means capable of moving between an open and closed position, for automatically releasing the closure means to thereby allow the closure means to open or close automatically.

The release means is operable in normal ambient temperature for automatically releasing the closure means and operable under fire conditions for automatically releasing the closure means.

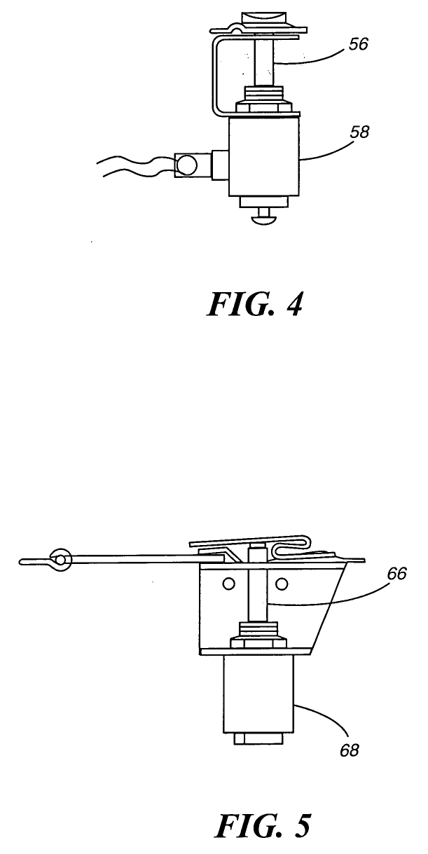

Alternatively, the pin can be the shaft 56 of a solenoid 58 FIG. 4 or the shaft 66 a pneumatically operated bellows 68 FIG. 5.

The detail FIG. 7 shows a detent, in this case, a double bevel configuration of the tip of the pin 29, to receive a pawl 23 that is directly attached to the door. This allows for insertion of the pawl manually in the latch mechanism to capture the pin, since the force applied by the door upon opening, overcomes the spring force of the clip's arm 31. It also provides for manual release of the door by pulling the pawl against the other beveled side of the tip of the pin 29.

The bi-metal clip is normally made of relatively thin metal; on the order of 0.050 inches thick. As a result it is only effective for light loads; on the order of a 70 pound limit. Over that force, it may spring open. Accordingly, I have invented several means for increasing the strength and load capacity of these devices.

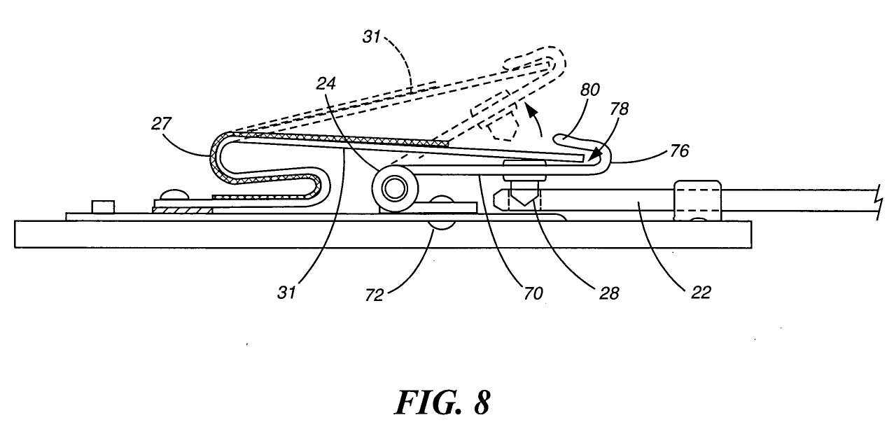

FIG. 8 shows an arrangement where a heavier gage metal hinge is used. The hinge 70 of approximately 0.090 inch thick metal is fixed to the mounting at 72 to rotate about its pivot 74. The free end 76 of the hinge is configured to curl back upon itself (as shown). The free end of the bi-metal clip arm 31 is nested in the envelop 78 created in the hinge. This greatly increases the force that the device can withstand without springing open. Here, the pin 28 is mounted on the free end of the hinge 70. When the bi-metal clip expands, the clip arm 31 engages the lip 80 of the hinge 70 and thereby pulls the pin 28 from the hole and releases the pawl 22.

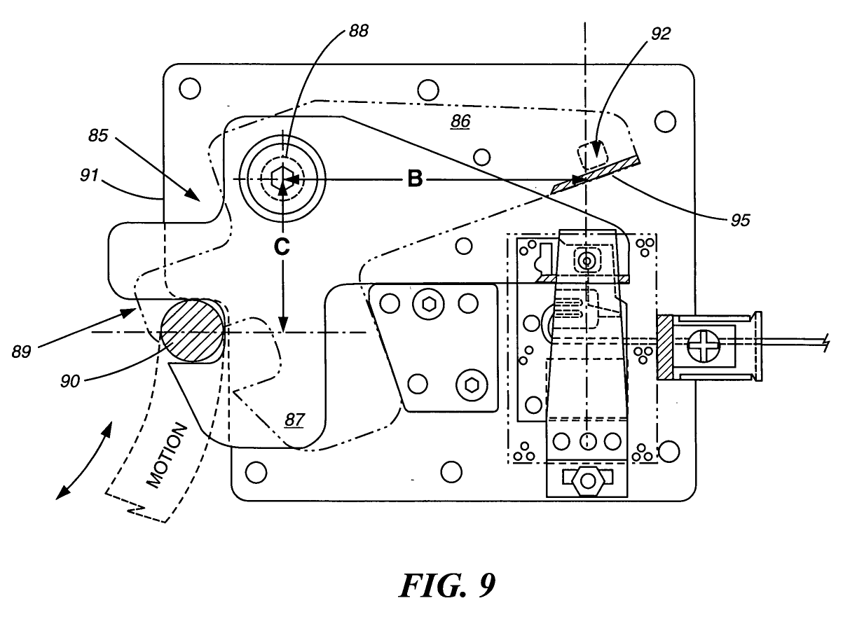

For even heavier loads, I have invented an even stronger device; as shown in FIG. 9. Therein, the pawl is part of a crank designated generally 85. The crank is made of a heavier gage material; for example, 0.125 inches thick. The crank has two crank arms, 86 and 87; which pivot about a shaft 88. By adjusting the respective lengths “B” and “C” of the crank arms 86 and 87 various mechanical advantages my be obtained thus providing for a variable load ratio. This adjustment may be made by one of ordinary mechanical skill.

The free end of the crank arm 87 has a yoke designated generally 89 for engaging a latch pin 90. The pin 90 is attached to a moveable member of a door, vent or the like and travels with it. Dimension “C” varies independently of “B” to control the interaction of the crank with the pin 90.

The free end of the crank arm 86 has a hole 92 in it to engage the pin extending from the free end of the bi-metal clip. The surface 95 is tapered to provide for ease of engagement with the pin. This pin is extracted to release the crank in the manner previously described with respect to other embodiments.

The reset of the crank arm into the clip is also similar, except that the latch pin 90 strikes the yoke end when a fire door is opened (or when a smoke vent cover is closed). The pin 90 strikes the base 91 to blunt the force of slamming the door or closure member shut; thereby preventing damage to the clip.

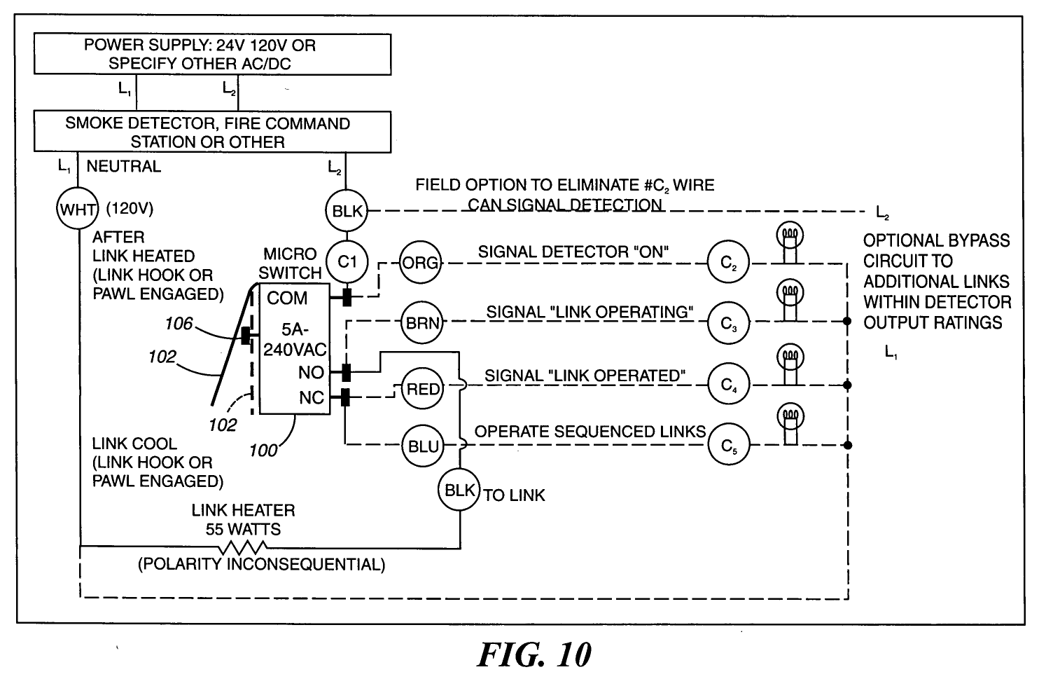

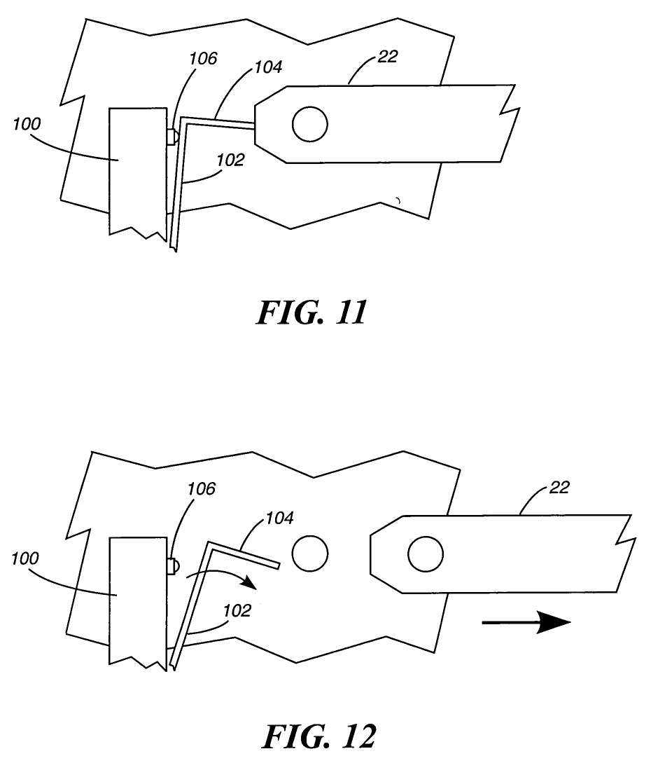

Note that hospital doors do not have built-in fire response release mechanisms. My mechanism can signal the door closure and double the signal as a fire detection signal. This can be accomplished by use of a micro switch 100 FIGS. 2, 10, 11 and 12. The switch 100 is mounted on the base 26. The switch arm 102 preferably has an extension 104 positioned to engage the end of the pawl 22. When the pawl is engaged and held in the mechanism, the switch arm 102 is touching the contact 106 of the micro-switch 100 (FIG. 11; FIG. 10, phantom line position). When the pawl is disengaged and released from the mechanism, the switch arm 102 is spaced from the contact 106 of the micro-switch 100 (FIG. 12; FIG. 10, full line position).

The switch 100 has three terminals which are used to make and break two circuits. The primary circuit is used to make the heater pad circuit when the pawl is engaged. That circuit is broken when the bi-metal clip (link) arm 31 moves to the position where the pawl is released.

When the heat of a fire releases the pawl, the other micro switch circuit (which is normally open) will be closed. In that case the clip will act as a fire detector by providing a signal. When the heated bi-metal clip release occurs, the connected circuit can be used to sound an alarm or operate other devices.

In the embodiment shown in FIG. 2, the pawl is engaged and the micro-switch arm 102 touches the micro-switch contact 106.

In the normally closed condition, the pawl is not engaged.

In FIG. 10 the micro switch terminals are labeled “NC” for normally closed and “NO” for normally opened. The word “OTHER” in the legend “SMOKE DETECTOR, FIRE COMMAND OR OTHER” refers to the Building Management System or other systems used to manage the building's functions. The small light bulb symbols refer to indicator lights to show activation of the circuits. The phrase “SEQUENCED LINKS” refers to other clips (links) on additional doors.

Another alternate embodiment is shown in FIG. 6 and FIG. 13. Therein, the micro-switch is mounted beside the bi-metal clip, so that as the clip arm 31 rises in the direction of the arrow “E” (due to heat), it contacts the micro-switch arm 102 and moves that arm from the position shown in full lines to the position shown in phantom lines; where it touches the micro-switch contact 106. This is most useful in the embodiment shown in FIG. 8; since in that embodiment, there may be insufficient room for the micro-switch to be positioned to engage the free end of the pawl 22. Thus instead of the pawl contacting the micro-switch arm 104/102, the clip arm 31 contacts the micro-switch arm 102. Here, however, the micro-switch arm 102 does not engage the clip arm 31 to force the micro-switch arm 102 to touch the contact 106 until after the arm 31 is raised by virtue of the application of heat. Note that the micro-switch has at least two circuits; one normally open and another normally closed. At lease one of these circuits is activated depending on the position of the micro-switch arm relative to the micro-switch contact, for supplying heat to said clip.

It will be understood by those of ordinary skill in the art that this last described arrangement could be altered to have the micro-switch arm 102 in contact with the micro-switch contact 106 when the arm of the clip 31 is in contact with the micro-switch arm 102; and to have the micro-switch arm 102 spaced from the micro-switch contact 106 when the positions are reversed.

1. A release means connected to a manually operable retaining means used for retaining a closure means capable of moving relative to an opening, between an open and a closed position; for automatically releasing the closure means to thereby allow the closure means to move to the open position or move to the closed position, automatically.

2. The release means of claim 1 operable in normal ambient temperature for automatically releasing the closure means and operable under fire conditions for automatically releasing the closure means.

3. The release means of claim 1, wherein the closure means is a door.

4. The release means of claim 1 wherein the manually operable retaining means comprises a pawl and pin.

5. The release means of claim 1 wherein the manually operable retaining means further comprises a magnet.

6. The release means of claim 1 wherein the manually operable retaining means further comprises a solenoid.

7. The release means of claim 1 wherein the manually operable retaining means further comprises a pneumatically operable bellows.

8. The release means of claim 1 wherein the release means further comprises a bi-metallic clip having an arm having a free end, said arm being cantilevered from a base and moveable relative to the base upon the application of heat, so that the free end moves away from the base.

9. The release means of claim 8 wherein the release means further comprises said pin being attached to said free end of said arm.

10. The release means of claim 9 further comprising a hole in said pawl confining said pin and thereby restraining said pawl; said pin being retractable from said hole to release said manually operable retaining means as a result of the application of heat to said bi-metallic clip.

11. The release means of claim 8 wherein the release means further comprises a hinge having a first portion and a second portion pivotally mounted thereto to pivot with respect to said first portion; said second portion having a free end remote from said pivotal mounting, said pin being attached to the free end of said second portion; and the pawl has a hole in it, confining said pin; said free end of said arm being positioned to engage the second portion of said hinge to pivot said second portion upon the application of heat to said bi-metallic clip; said pin being retractable from said hole to release said manually operable retaining means upon the application of heat to said bi-metallic clip and the movement of said second portion of said hinge.

11. The release means of claim 4 wherein the manually operable retaining means further comprises a double beveled free end on said pin.

12. The release means of claim 4 wherein the manually operable retaining means further comprises a guide juxtaposed to said pawl to guide said pawl.

13. The release means of claim 4 wherein said pawl is one arm of a crank; and said crank is pivotally mounted to pivot about a shaft; and said pawl has a hole in it remote from said shaft; said hole confining said pin; said pin being retractable from said hole to release said manually operable retaining means.

14. The release means of claim 13 wherein said crank has a second arm having a latch means to latch onto and thereby retain said closure means.

15. The release means of claim 4 further comprising a micro-switch juxtaposed to said pawl; said micro-switch having a contact and an arm moveable toward and away from said contact; said pawl having a hole in it; said hole confining said pin; said pin being retractable from said hole to release said manually operable retaining means; said pawl and micro-switch being positioned such that when the pin is in the hole in the pawl, the micro-switch arm is touching the contact of the micro-switch; and when the pawl is disengaged and released from the pin, the micro-switch arm is spaced from the contact of the micro-switch.

16. The release means of claim 15 wherein the micro-switch has at least two circuits; at lease one of which is activated depending on the position of the micro-switch arm relative to the micro-switch contact, for supplying heat to said clip.

17. The release means of claim 16 further comprising a second circuit associated with said micro-switch such that when heat releases the pawl, this second micro-switch circuit will be closed and act as a fire detector by providing a signal.

18. The release means of claim 4 further comprising a bi-metallic clip having a moveable arm having a free end, said arm being cantilevered from a base and said free end being moveable relative to the base upon the application of heat, so that the free end moves away from the base; said pawl having a hole in it confining said pin and positioned such that the pin is retracted from said hole upon the application of heat to said clip to thereby release said retaining means; and further comprising a micro-switch juxtaposed to said moveable arm of said bi-metallic clip; said micro-switch having a contact and an arm moveable toward and away from said contact; and said micro-switch being positioned such that when the pin is in the hole in the pawl, the micro-switch arm is touching the contact of the micro-switch; and when the pin is disengaged from the pawl, the micro-switch arm is spaced from the contact of the micro-switch.

19. The release means of claim 18 wherein the micro-switch has at least two circuits; at lease one of which is activated depending on the position of the micro-switch arm relative to the micro-switch contact, for supplying heat to said clip.

20. The release means of claim 4 further comprising a bi-metallic clip having a moveable arm having a free end, said arm being cantilevered from a base and the free end being moveable relative to the base upon the application of heat, so that the free end moves away from the base; said pawl having a hole in it confining said pin and positioned such that the pin is retracted from said hole upon the application of heat to said clip to thereby release said retaining means; and further comprising a micro-switch having a contact and an arm moveable toward and away from said contact; said micro-switch being juxtaposed to said moveable arm of said bi-metallic clip such that the moveable arm of said micro-switch can selectively engage said moveable arm of said bi-metallic clip, upon movement of said bi-metallic clip arm.
